(19) United States
(12) Patent Application Publication
(10) Pub. No.: US 2005/0082772 A1
(43) Pub. Date: Apr. 21, 2005

(54) Method of moving a trailer assembly between elevated and lowered positions

(76) Inventor: Donald Hunley, Howell, MI (US)

Correspondence Address: David J. Simonelli;Clark Hill PLC, Suite 3500, 500 Woodward Ave., Detroit, MI, 48226-3435, US

(21) Appl. No.: 10/937,984

(22) Filed: Sep. 10, 2004

Related U.S. Application Data
(60) Provisional application No. 60/501,705, filed on Sep. 10, 2003.

(51) Int. Cl. B62D 37/00

(52) U.S. Cl. 280/6.15

(57) ABSTRACT

The invention relates to a method of moving a trailer assembly between a transport position, coupled to a mode of transportation, and a storage position. A trailer assembly typically includes, among other things, a base and an axle/suspension carriage. The trailer assembly also includes a lifting mechanism that is operatively connected between the axle/suspension carriage and the base and is movable between an extended position and a retracted position. The method includes the step of transporting the trailer assembly to a desired location for storage with the axle/suspension carriage in the extended position. The lifting mechanism is then actuated to adjust the axle/suspension carriage to a position between the extended position and the retracted position while continuing to transport the trailer assembly to the desired location. The lifting mechanism is then released allowing the axle/suspension carriage to move toward the retracted position when the trailer assembly is in the desired location such that the trailer assembly has a minimal profile at the desired location.

### BACKGROUND ART

1. Field of the Invention

The invention relates to trailer assemblies. More specifically, the invention relates to a method of moving a trailer assembly between an elevated position and a lowered position.

2. Description of the Related Art

Typically, trailers are used to transport items to a desired location. Many times, trailers are also used as structures designed to be inhabited for a particular purpose. The environments found within these trailers can be full of equipment to facilitate a particular operation. By way of example, an environment for a trailer may be used as a classroom, an office, a conference center, a health system/counseling center, a mobile command center, and the like. It should be appreciated by those skilled in the art that any type of function that is performed within an enclosed space may be performed within a trailer environment.

To make a trailer more versatile, a trailer may be designed to expand to a greater volume once the trailer has been moved into the desired location for the operation. The same trailer is also collapsible into a smaller volume allowing it to be transported using the road system. Typically, a secondary volume that is smaller than a primary volume of space extends between a collapsed position and an expanded position. This allows a trailer of normal dimensions to be transported to a remote location and then expanded thereat to enhance the functionality of the trailer.

These expandable and collapsible trailers fail to contemplate multiple modes of transportation. More specifically, these trailers are designed to be transported over the road system using tractors or trucks. The trailers are not, however, designed to be transported efficiently by rail, sea or air.

### SUMMARY OF THE INVENTION

The invention relates to a method of moving a trailer assembly between a transport position, coupled to a mode of transportation, and a storage position. A trailer assembly typically includes, among other things, a base and an axle/suspension carriage. The trailer assembly also includes a lifting mechanism that is operatively connected between the axle/suspension carriage and the base and is movable between an extended position and a retracted position. The method includes the step of transporting the trailer assembly to a desired location for storage with the axle/suspension carriage in the extended position. The lifting mechanism is then actuated to adjust the axle/suspension carriage to a position between the extended position and the retracted position while continuing to transport the trailer assembly to the desired location. The lifting mechanism is then released allowing the axle/suspension carriage to move toward the retracted position when the trailer assembly is in the desired location such that the trailer assembly has a minimal profile at the desired location.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a side view of one embodiment of the invention with an axle/suspension carriage in an extended position;

FIG. 2 is a side view of one embodiment of the invention with the axle/suspension carriage in a retracted position;

FIG. 3 is a top view of one embodiment of the invention with a secondary enclosure in an expanded position;

FIG. 4 is a front view of one embodiment of the invention with the axle/suspension carriage in the extended position;

FIG. 5 is a side view of one embodiment of the invention with the axle/suspension carriage in an intermediate position and a trailer assembly coupled to a mode of transportation;

FIG. 6 is a side view of one embodiment of the invention with the axle/suspension carriage in the intermediate position and the trailer assembly coupled to the mode of transportation; and

FIG. 7 is a side view of one embodiment of the invention with the axle/suspension carriage in the retracted position.

### DETAILED DESCRIPTION OF THE PREFERRED EMBODIMENT

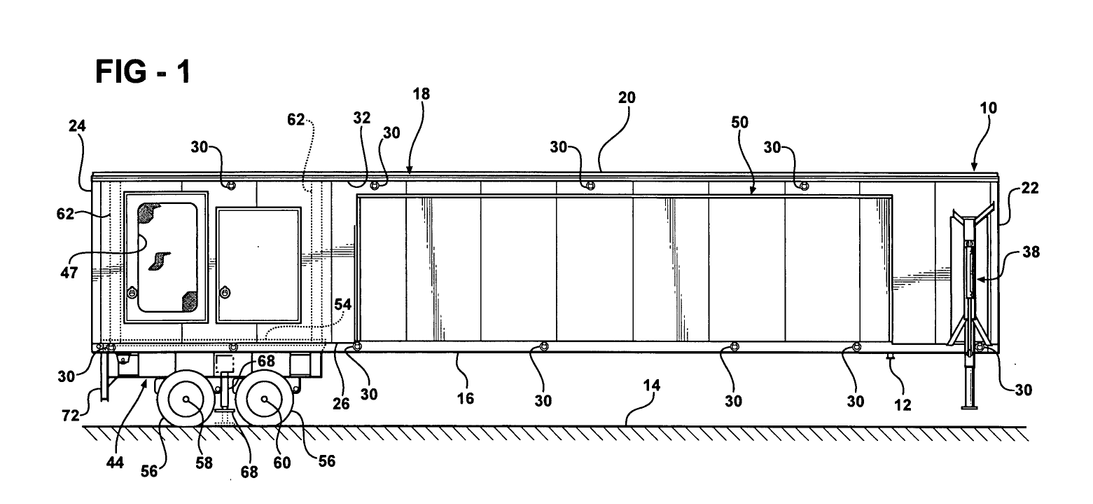

Referring to FIGS. 1 through 3, a trailer assembly is generally indicated at 10. While the trailer assembly 10 may be any general size, the trailer assembly 10 shown in the Figures is typically referred to as a “semi trailer.” The trailer assembly 10 includes a king pin 12 that allows the trailer assembly 10 to be coupled to a mode of transport, such as a truck 13 or a tractor, for travel along a road system or other transport surface 14.

The trailer assembly 10 defines a base 16. A primary enclosure, generally indicated at 18, extends upwardly from the base 16. The primary enclosure 18 includes a roof 20, a front wall 22, a rear wall 24, and a pair of sidewalls 26, 28 each extending between the front 22 and rear 24 walls. A plurality of D-rings or tie downs 30 are fixedly secured along the base 16 and the roof 20 for securing a load thereto. The trailer assembly 10 also includes anchors 31 capable of securing a lifting harness 33 thereto so a crane could lift the trailer assembly 10 into a freighter or ship.

The primary enclosure 18 defines a primary interior space 32. It is within the primary interior space 32 that a majority of the space and the equipment stored by the trailer assembly 10 are located.

The primary enclosure 18 also includes a front interior partition 34, which along with the front wall 22 and the pair of sidewalls 26, 28 defines a forward compartment 36. The forward compartment 36 houses a forward stand assembly, generally indicated at 38 and described in greater detail below.

A computer workstation 37 is disposed adjacent the front interior partition 34 opposite the forward compartment 36. It will be appreciated that although a computer workstation 37 is shown, any of a number of items could be placed adjacent the front interior partition 34 to fulfill the particular needs of each trailer assembly owner.

In addition, the primary enclosure 18 includes a rear interior partition 40 that cooperates with the rear wall 24 and the pair of sidewalls 26, 28 to define a rearward compartment 42. The rearward compartment 42 houses an axle/suspension carriage, generally indicated at 44, a generator 46, and a cable power reel 48. The generator 46 is housed behind a generator housing grill 47, which helps ventilate the trailer assembly 10.

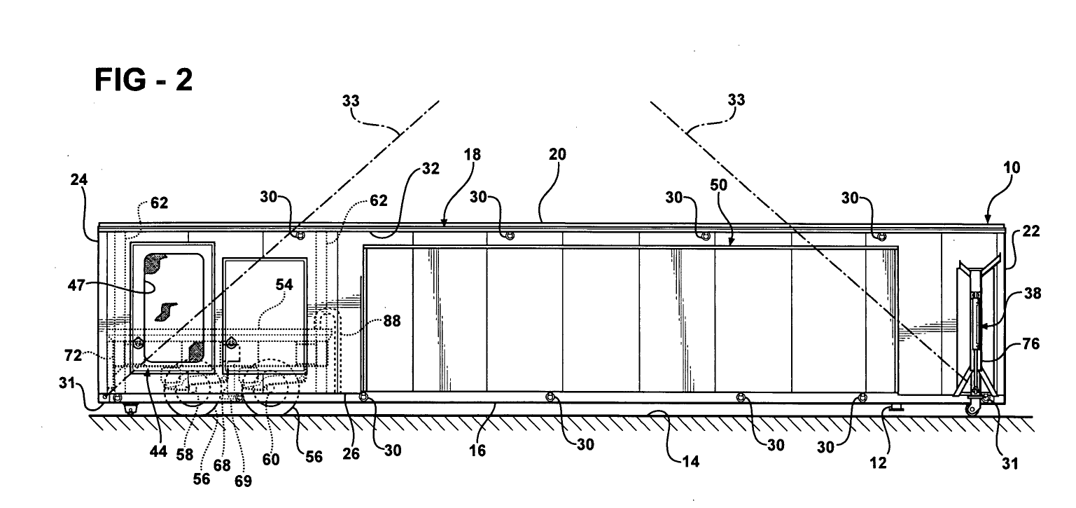

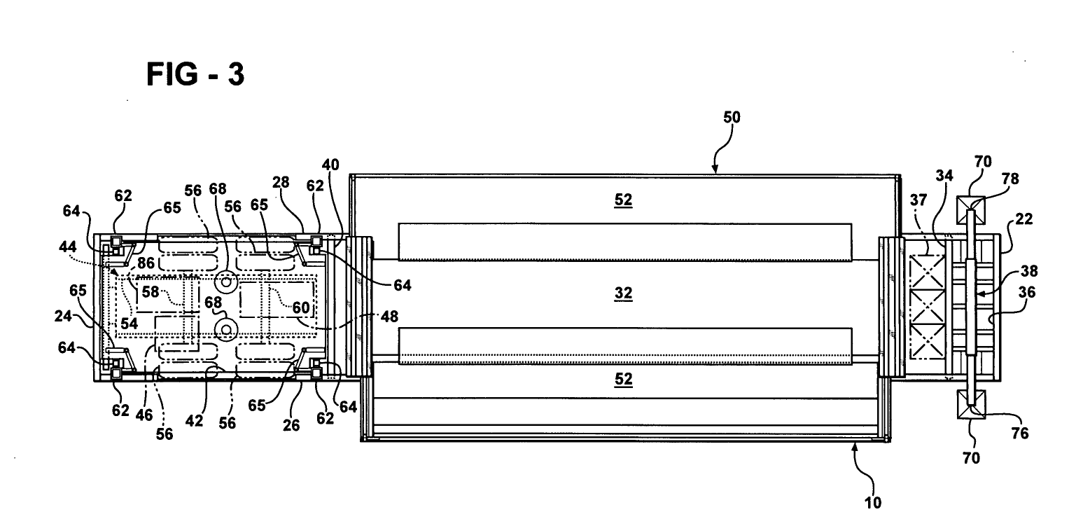

The trailer assembly 10 also includes a secondary enclosure, generally shown at 50. The secondary enclosure 50 defines a secondary interior space 52, which is smaller than the primary interior space 32. The secondary enclosure 50 telescopes in and out of the primary interior space 32, as is known to those skilled in the art. Thus, the secondary enclosure 50 is movable between a collapsed position, as is shown in FIGS. 1 and 2, and an expanded position, as is shown in FIG. 3. It will be appreciated that although the trailer assembly 10 is shown having two secondary enclosures 50 (one telescoping out from each of the pair of sidewalls 26, 28), the trailer assembly 10 may have only one secondary enclosure telescoping out from one of the pair of sidewalls 26, 28.

When the secondary enclosure 50 is in the collapsed position, the trailer assembly 10 is capable of being stored efficiently. The trailer assembly 10 is also more transportable via the road system 14 when the secondary enclosure 50 is in the collapsed position. When the secondary enclosure 50 is in the expanded position, the total amount of space within the trailer assembly 10 is increased to accommodate various mobile work environments.

The axle/suspension carriage 44 includes a carriage platform 54 having a plurality of wheels 56 rotatably secured thereto for transporting the trailer assembly 10 via the road system 14. The axle/suspension carriage 44 is shown to have two sub-axles 58, 60. It should be appreciated by those skilled in the art that although two sub-axles are shown in FIGS. 1 through 3, the axle/suspension carriage 44 may have any number of sub-axles.

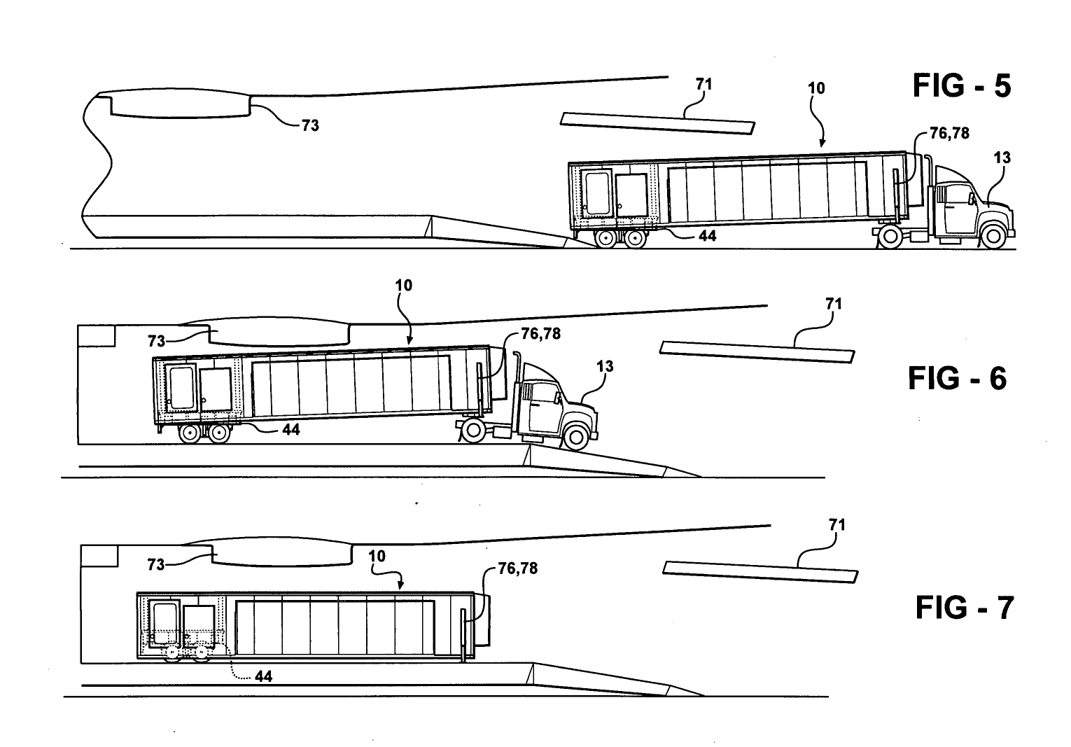

The rearward compartment 42 includes a plurality of vertically extending track members 62 disposed along the pair of sidewalls 26, 28 between the base 16 and the roof 20. The carriage platform 54 includes a plurality of bearing members 64 aligned with the plurality of vertically extending track members 62. The plurality of bearing members 64 slidingly engage the plurality of vertically extending track members 62 to provide vertical movement of the axle/suspension carriage 44 between an extended position (FIG. 1) and a retracted position (FIGS. 2 and 7), and a supported or intermediate position therebetween (FIGS. 5 and 6). A plurality of locking mechanisms 65 selectively retains the axle/suspension carriage 44 in the extended position or any of the plurality of supported positions.

A lifting mechanism 64 is fixedly secured to the base 16 and initiates movement of the axle/suspension carriage 44 along the plurality of vertically extending track members 62 between the extended and retracted positions. The lifting mechanism 64 is shown in the Figures as a hydraulic mechanism, discussed subsequently. It should be appreciated by those skilled in the art that mechanical and/or electrical systems might be incorporated as required by the capabilities of the trailer assembly 10 and the environments in which the trailer assembly 10 is going to be deployed.

When the axle/suspension carriage 44 is in the extended position, the trailer assembly 10 is in an elevated position due to the positioning of the plurality of wheels 56 substantially lower than the rearward compartment 42. More specifically, the trailer assembly 10 is in the elevated position because the axle/suspension carriage 44 is extended forcing the plurality of wheels 56 downwardly away from the rearward compartment 42. The trailer assembly 10 can be coupled with a mode of transport via the king pin 12 to allow travel of the trailer assembly 10.

A stabilizing leg 68 is fixedly secured to the axle/suspension carriage 44. The stabilizing leg 68 includes a landing pad 69 that selectively contacts the road system 14. More particularly, the landing pad 69 is moved into contact with the road system 14 to assist in maintaining the trailer assembly 10 stationary when the axle/suspension carriage 44 is in both the retracted and extended positions.

When the axle/suspension carriage 44 is in the retracted position, the trailer assembly 10 is in a lowered position due to the fact that a portion of the axle/suspension carriage 44 is located within the rearward compartment 42. This reduces the height of the trailer assembly 10, which in turn reduces the overall volume consumed thereby. Thus, when the axle/suspension carriage 44 is in the retracted position, the trailer assembly 10 is able to fit inside or on top of various modes of transport, one example being inside of a military transport aircraft. As a result, the trailer assembly 10 may be efficiently stowed and transported via rail, sea and/or air.

The movement of the axle/suspension carriage 44 between its extended and retracted positions allows the trailer assembly 10 to be airlifted to a remote location and subsequently be moved away from the airport (or landing location) using the plurality of wheels 56 after they are moved to the extended position.

A rear bumper 72 is fixedly secured to the axle/suspension carriage 44. When the axle/suspension carriage 44 is in its extended position, the rear bumper 72 is in an operative position extending below the base 16 of the trailer assembly 10. When the axle/suspension carriage 44 is in its retracted position, the rear bumper 72 is located within the rearward compartment 42 so as not to interfere with stowage and transport of the trailer assembly 10 via rail and/or air.

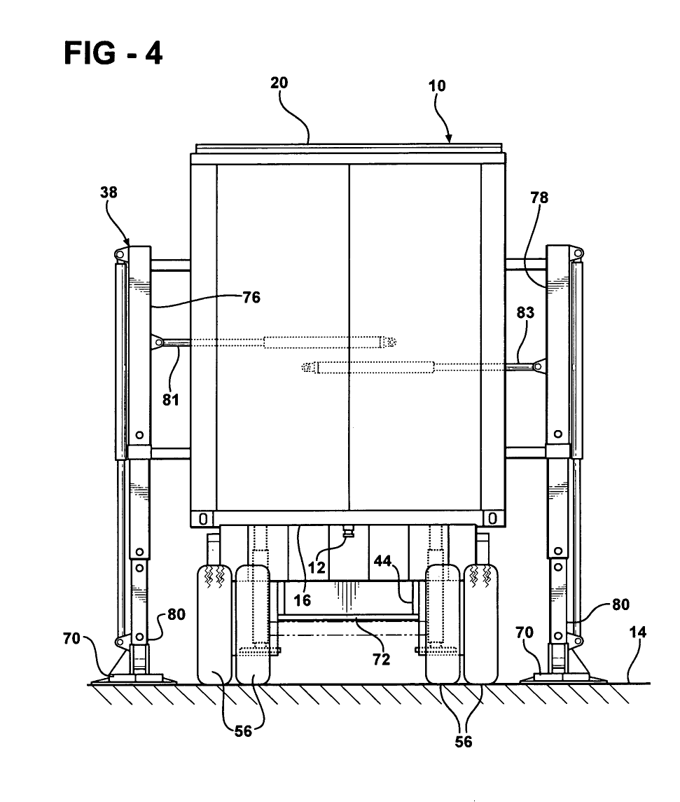

Referring to FIG. 4, the forward stand assembly 38 holds the trailer assembly 10 level when the axle/suspension carriage 44 is deployed to its extended position. The forward stand assembly 38 can be moved in concert with the axle/suspension carriage 44 to prevent the base 16 from moving in a non-parallel manner with respect to the road system 14 below it. The forward stand assembly 38 telescopes between a stowed position, as shown in FIG. 2, and a support position, as shown in FIGS. 1 and 4.

The forward stand assembly 38 is fixedly secured to the base 16 and includes a pair of support legs 76, 78, each terminating at a distal end 80 having a pad 70, preferably made of aluminum, secured thereto. When the forward stand assembly 38 is in the support position, each of the support legs 76, 78 is moved out and away from the forward compartment 36 using telescoping extensions 81, 83. The outward positioning of the support legs 76, 78 supports the base 16 while simultaneously allowing the truck 13 access to the centrally located king pin 12. More specifically, the truck 13 is able to back up underneath the trailer assembly 10 and access the king pin 12 without interference from the forward stand assembly 38.

In use, the trailer assembly 10 can be moved to a desired location by the mode of transportation, while the axle/suspension carriage 44 remains in the extended position, as shown in FIGS. 1 and 4. While moving the trailer assembly 10 to the desired position, the axle/suspension carriage 44 can be adjusted to and maintained in any of the plurality of supported positions between the extended and retracted positions to avoid obstacles, such as a low overhanging wall 71. As may be seen when viewing FIGS. 5 and 6, the lifting mechanism 64 lowers the base 16 by having the axle/suspension carriage 44 move partially into the rearward compartment 42.

When the trailer assembly 10 is in the desired location, the forward stand assembly 38 is extended to the support position, as best shown in FIG. 1. The support legs 76, 78 are moved outwardly relative to the forward compartment by the telescoping extensions 81, 83 to facilitate disconnection of the trailer assembly 10 from the mode of transport. If necessary, the stabilizing leg 68 can be lowered to keep the trailer assembly 10 stationary while axle/suspension carriage 44 is in the extended position. After the mode of transport has been disconnected and removed from under the base 16, the trailer assembly 10 can be lowered from the intermediate position, as shown in FIG. 6, to the storage position, as shown in FIG. 7, to minimize the profile of the trailer assembly 10 at the desired location. The forward assembly 38 acts in unison with the axle/suspension carriage 44, or the lifting mechanism 64, to lower the trailer assembly 10 to its reduced profile position. Depending on what is stored in the trailer assembly 10, it may be important to be able to lower the trailer assembly 10 while maintaining its orientation parallel to the ground. The above described operation is reversed to return the trailer assembly 10 from the storage position to the transport position, such that the king pin 12 is presented for re-attachment to the mode of transportation.

Returning attention specifically to FIG. 6, the trailer assembly 10 is shown in a position intermediate the elevated position and the storage position. The axle/suspension carriage 44 is capable of maintaining the trailer assembly 10 in any one of a plurality of intermediate positions. By having the ability to lock the axle/suspension carriage 44 in any one of the plurality of positions allows the trailer assembly 10 the ability to be moved into areas of varying clearances, e.g., the space shown in FIG. 6. In this space, the trailer assembly 10 can be lowered by moving the axle/suspension carriage 44 to one of the plurality of intermediate positions to avoid the overhanging wall 71 and a ceiling protrusion 73. Positioning the axle/suspension carriage 44 at intermediate positions provide the opportunity to maintain the trailer assembly 10 in a movable condition while maintaining it as level as possible.

The forward stand assembly 38 and the axle/suspension carrier 44 can be operated cooperatively to move the trailer assembly 10 between the transport position and storage position or any position therebetween, while maintaining the trailer assembly 10 in any longitudinal orientation, such as parallel to the ground or horizontal. Control of the movements of the forward stand assembly 38 and the axle/suspension carrier 44 may be done manually or electronically using a control circuit designed to coordinate this reciprocating motion.

To further discuss the manual operation of the axle/suspension carriage 44, a hydraulic unit 86 is used to raise and lower the trailer assembly 10. The hydraulic unit 86 is fixedly secured to the platform 54 or a similar stationary portion of the trailer assembly 10 and forces the carriage platform 54 and the axle/suspension carriage 44 downwardly.

Because several powered components are secured to the carriage platform 54, a robotic track 88 is used to maintain an electrical connection between the primary enclosure 18, the computer workstations 37 and the rearward compartment 42. The robotic track 88 includes a plurality of hinged components that allow each component to roll over the other to ensure the electrical connection is maintained. The robotic track 88 obviates the need for a soft wire harness.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

1. A method of moving a trailer assembly between a transport position coupled to a mode of transportation and a storage position, the trailer assembly including a base, an axle/suspension carriage and a lifting mechanism operatively connecting the axle/suspension carriage to the base and movable between an extended position and a retracted position, the method comprising the steps of:
transporting the trailer assembly to a desired location for storage with the axle/suspension carriage in the extended position;
actuating the lifting mechanism to adjust the axle/suspension carriage to a position between the extended position and the retracted position while transporting the trailer assembly to the desired location; and
releasing the lifting mechanism allowing the axle/suspension carriage to move toward the retracted position when the trailer assembly is in the desired location, such that the trailer assembly has a minimal profile at the desired location.

2. A method of moving a trailer assembly between a transport position coupled to a mode of transportation and a storage position, the trailer assembly including a base, an axle/suspension carriage, a lifting mechanism operatively connecting the axle/suspension carriage to the base and movable between an extended position and a retracted position, and a forward stand assembly operatively coupled with the base and movable between a stowed position and a support position, the method comprising the steps of:
transporting the trailer assembly to a desired location for storage with the axle/suspension carriage in the extended position;
actuating the lifting mechanism to move the axle/suspension carriage to a position between the extended position and the retracted position to continue moving the trailer assembly to the desired location;
releasing the lifting mechanism to allow movement of the axle/suspension carriage between the extended and retracted positions; and
moving the forward stand assembly between the stowed and support positions in concert with the movement of the axle/suspension carriage between the retracted and extended positions, respectively, when the trailer assembly is in the desired location, such that the trailer assembly moves between the transport and storage positions in a parallel manner with respect to the ground.

3. The method as set forth in claim 2 wherein the step of moving the trailer assembly to the desired location includes adjusting the axle/suspension carriage among the plurality of intermediate positions to avoid interference with obstacles while transporting the trailer assembly to the desired location.

4. The method as set forth in claim 3 including the step of maintaining the forward stand assembly in the extended position prior to movement toward the retracted position to allow the trailer assembly to be disconnected from the mode of transportation.

5. The method as set forth in claim 4 including the step of maintaining the trailer assembly in the elevated position until after the mode of transportation has been removed from under the trailer assembly.
